(19) United States
(12) Patent Application Publication
(10) Pub. No.: US 2005/0014540 A1
(43) Pub. Date: Jan. 20, 2005

(54) Antenna coupling reduction apparatus and method

(75) Inventor: Joo-Heon Shim, Gyeonggi-Do (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: LG Electronic Inc.

(21) Appl. No.: 10/831,512

(22) Filed: Apr. 23, 2004

(30) Foreign Application Priority Data
Apr. 25, 2003 (KR) 26455/2003

(51) Int. Cl. H04B 1/06; H04B 7/00; H04B 7/185

(52) U.S. Cl. 455/575.7; 455/272

(57) ABSTRACT

The present invention provides an antenna coupling preventing system and method capable of minimizing coupling between a GPS antenna and a CDMA antenna. The system comprises first and second antennas for receiving first and second RF signals of first and second frequencies, respectively; a mobile switch for measuring performance characteristics of the second antenna; and a switch circuit connected between the second antenna and the mobile switch for controlling flow of the first RF signal to the second antenna.

### CROSS-REFERENCE TO RELATED APPLICATIONS

Pursuant to 35 U.S.C. § 119(a), this application claims the benefit of earlier filing date and right of priority to the Korean Patent Application No. 2003-26455, filed on Apr. 25, 2003, the content of which is hereby incorporated by reference in its entirety.

### BACKGROUND OF THE INVENTION

1. Field of the Invention

The present invention relates to an antenna coupling prevention apparatus and method and more particularly to a method for minimizing coupling between a GPS antenna and a CDMA antenna in a CDMA terminal having a GPS function.

2. Description of the Related Art

A CDMA terminal having a GPS function under development may use two different antennas (GPS and CDMA antennas) in order to receive both GPS signal and CDMA signal (cellular, PCS). Unfortunately, coupling between two bands (CDMA and GPS) may occur in the CDMA or the GPS antenna. Thus, without removing or attenuating the coupling, it is difficult to obtain a desired GPS radio sensitivity.

When the coupling is detected in the CDMA terminal in a related art, one of the CDMA antenna or the GPS antenna is tuned again or a printed circuit board (PCB) is used to correct the problem. However, such series of operations take much time and are not highly effective.

During fabrication of a terminal, after the GPS antenna is tuned, a matching value of the CDMA antenna is changed in order to measure a specific absorption ratio (SAR) or improve radio sensitivity. At this point, if there is any coupling, then GPS antenna should be tuned again. In addition, since the SAR or the radio sensitivity are factors changing until right before mass production, the GPS antenna needs to be tuned repeatedly until right before the mass production.

Therefore, for the purpose of minimizing coupling between the GPS antenna and the CDMA antenna, development of an antenna coupling preventing apparatus and defining a position for inserting the corresponding apparatus are required.

### SUMMARY OF THE INVENTION

The present invention provides an antenna coupling preventing system and method capable of minimizing coupling between a GPS antenna and a CDMA antenna. In accordance with one embodiment, the system comprises first and second antennas for receiving first and second RF signals of first and second frequencies, respectively; a mobile switch for measuring performance characteristics of the second antenna; and a switch circuit connected between the second antenna and the mobile switch for controlling flow of the first RF signal to the second antenna.

When the terminal is in a first mode, the switch circuit changes an input impedance of the second antenna to a first level to cut off flow of the first RF signal. When the terminal is in a second mode, the switch circuit changes the input impedance of the second antenna to a second level to allow the second RF signal to flow to a diplexer. The second signal comprises a DCN (Digital Cellular Network) signal and a PCS (Personal Communication Service) signal.

In one embodiment, the switch circuit comprises a choke coil for transmitting a control signal to a diode; a conducting means connected between the second antenna and a load for controlling flow of the second RF signal received by the second antenna according to the control signal; and a transmission line for transmitting the second RF signal which has passed the conducting means, to the diplexer.

The conducting means is a pin diode. The control signal is provided by a mobile station modem (MSM). In one embodiment, the control signal is provided at a first level in the GPS mode, and at a second level in the CDMA mode. The conducting means increases impedance of the second antenna to cut off inflow of the RF signal.

In accordance to another embodiment, a signal coupling prevention system for a mobile communication terminal having separated GPS antenna and CDMA antenna for receiving respective GPS and CDMA signals is provided. A switch circuit for controlling an input impedance of the CDMA antenna is connected between the CDMA antenna and a mobile switch to cut off a first RF signal received by the CDMA antenna in a GPS operation mode and to allow passing of a second RF signal received by the CDMA antenna in a CDMA operation mode.

The first RF signal is a GPS signal and the second RF signal is a CDMA signal. The switch circuit comprises a choke coil for transmitting a control signal for controlling input impedance of the CDMA antenna to a diode; a conducting mechanism connected between the CDMA antenna and a load for cutting off or allowing the second RF signal to pass according to the control signal; and a transmission line for connecting the conducting mechanism to a diplexer. The control signal is provided from a mobile station modem (MSM) and has a low level in the GPS mode and a high level in the CDMA mode.

In accordance with yet another embodiment, antenna coupling preventing apparatus for a mobile communication terminal having a GPS antenna and a CDMA antenna to receive a GPS signal and a CDMA signal, wherein an input impedance of the CDMA antenna is maintained high in a GPS operation mode to cut off inflow of a GPS signal, and the input impedance of the CDMA antenna is maintained low in a CDMA operation mode to receive a CDMA signal.

In one embodiment, an antenna coupling preventing apparatus comprises first and second antennas for receiving first and second RF signals respectively, having first and second frequencies; and a switch circuit connected to the first antenna for cutting off inflow of the second RF signal, received by the second antenna, to the first antenna. The first antenna receives a GPS (Global Positioning System) signal and the second antenna receives a CDMA (Code Division Multiple Access) signal.

The switch circuit is connected between the first antenna and a mobile switch measuring performance of wired characteristics of the first antenna. The switch circuit maintains a first impedance in order to cut off inflow of the first signal to the second antenna if the CDMA signal is received by the first antenna, the switch circuit maintains a second input impedance to prevent coupling with a GPS signal received by the second antenna. In one embodiment, the CDMA signal comprises at least of one of a PCS (Personal Communication Service) signal and a DCN (Digital Cellular Network) signal.

In accordance with yet another embodiment, a method for reducing coupling between a first antenna and a second antenna of a mobile terminal is provided wherein the first antenna is configured to receive a first signal and a second antenna is configured to receive a second signal. The method comprises setting a first impedance for the first antenna to prevent flow of the second signal in the first antenna; when the mobile terminal is in a second reception mode; and setting a second impendence for the first antenna to allow flow of the first signal in the first antenna, when the mobile terminal is in a first reception mode.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements.

FIG. 1 illustrates an antenna coupling preventing apparatus in accordance with a preferred embodiment of the present invention.

FIG. 2 illustrates an exemplary construction of a switch circuit of FIG. 1;

FIG. 3 is a Smith chart showing an impedance of a CDMA antenna when a terminal operates in a GPS mode, in one embodiment.

FIG. 4 is a Smith chart showing an impedance of a CDMA antenna when a terminal operates in a CDMA mode, in accordance with one embodiment.

FIG. 5 is a table showing a signal loss, according to one embodiment when the terminal operates in the CDMA mode.

### DETAILED DESCRIPTION OF THE PREFERRED EMBODIMENTS

In the following, one embodiment of the invention is disclosed as applicable to a CDMA terminal having a GPS function, namely, to a mobile communication terminal using two different antennas (GPS antenna and CDMA antenna). It is noteworthy, however, that the above application is by way of example. As such, the principles of the invention may be applied to any two or more antennas for receiving data on separate frequencies, and over various communication technologies (e.g., CDMA, GSM, TDMA, etc.)

Referring to FIG. 1, in accordance with one embodiment of the invention, a coupling prevention system comprises: a CDMA antenna 10 for receiving a CDMA signal;. a matching circuit 11 for matching a mating value of the CDMA antenna 10 to a certain impedance (50 ohm); a GPS antenna 20 for receiving a GPS signal; mobile switches 13 and 21 for testing the performance of the wires connected to the CDMA antenna 10 and the GPS antenna 20, respectively; a diplexer 14 for separating a PCS (Personal Communication Service) signal and a DCN (Digital Cellular Network) signal from the CDMA signal; and a switch circuit 12 for reducing an antenna coupling generated between the CDMA antenna 10 and the GPS antenna 20. Reference numeral 22 denotes a GPS filter for filtering a frequency of GPS band.

In one embodiment of the invention, the switch circuit 12 is connected between the CDMA antenna 10 and the mobile switch 13 in order to prevent the GPS signal from interfering with a CDMA signal (PCS and DCN signal) frequency near the GPS signal frequency (1.5 GHz).

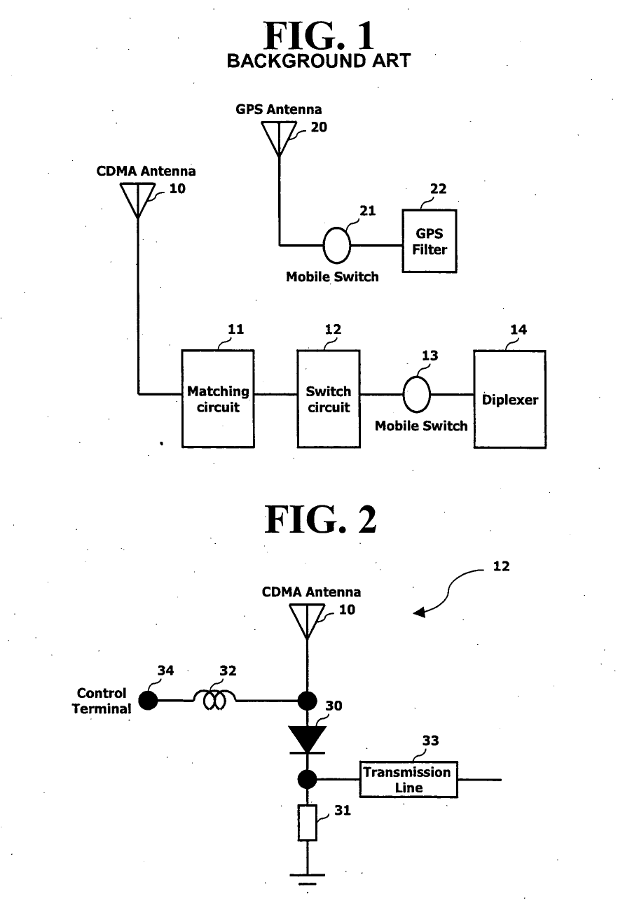

As shown in FIG. 2, the switch circuit 12 comprises a diode 30 connected between the CDMA antenna 10 and a load 31 and controlling inflow of an RF signal (CDMA) received by the CDMA antenna according to a digital control signal (referred to as ‘control signal’, hereinafter), a choke coil 32 for transmitting the control signal to the diode 30, and a transmission line 33 for transmitting the RF signal which has passed the diode 30 to the diplexer 14.

Preferably, the transmission line. 33 is implemented as a quarter-wavelength line, and the diode 30 is a pin diode. The RF signal signifies a CDMA signal and the control signal, which is a signal corresponding to an operation mode of the terminal, is outputted from the MSM (Mobile Station Modem) of the terminal, for example.

In one embodiment, the CDMA terminal having the GPS function receives a CDMA signal or a GPS signal through the CDMA antenna 10 or the GPS antenna 20 according to an operation mode (the CDMA mode or the GPS mode). The CDMA antenna 10 receives a CDMA signal of 800 MHz, 1.9 GHz band and the GPS antenna 20 receives a GPS signal of 1.5 GHz band, for example.

In such a case, because the CDMA antenna 10 and the GPS antenna 20 of the CDMA terminal can respectively receive a signal of a partially similar frequency band, coupling may occur when the GPS signal flows into the CDMA antenna, and likewise, when CDMA signal flows in the GPS antenna.

In order to prevent such a phenomenon, when the terminal operates in the GPS mode, the switch circuit 12 changes an impedance of the main CDMA antenna to be infinitely large in order to prevent the CDMA signal from flowing into the GPS signal path, thereby preventing loss of the GPS signal possibly caused by the coupling.

It is noteworthy that the system may also be implemented so that when the terminal operates in the CDMA mode, a switch circuit may be used to change the impedance of the GPS antenna to be infinitely large in order to prevent the GPS signal from flowing into the CDMA signal path, thereby preventing loss of CDMA signal possibly caused by coupling. In the following, exemplary embodiments are provided that may be directed toward one or the other of the above noted systems. As such, the concept disclosed herein may be interchangeably applied to any two or more antennas designed to receive communication in close frequency bands.

For example, when the terminal operates in the GPS mode, the RF signal of 1.5 G band received by the GPS antenna 20 is inputted to the GPS filter 22 through the mobile switch 21. The GPS filter 22 filters a frequency of the GPS signal band from the RF signal. Then, the MSM of the terminal generates a low level control signal (e.g., zero) and outputs it to a control terminal 34 of the switch circuit 12. The control signal, which has been inputted to the control terminal 34 is transmitted to the diode 30 through the choke coil 32 to turn off the diode 30.

Once the diode 30 is turned off, the impedance of the CDMA antenna 10 becomes high, so that any RF signal as well as the GPS signal cannot flow into the CDMA antenna 10. Accordingly, when the terminal operates in the GPS mode, the CDMA signal does not flow to the GPS signal path by means of the switch circuit 12, so that the GPS signal filtered in the GPS filter 22 can maintain desired radio sensitivity.

In one embodiment, when the terminal operates in the CDMA mode, the MSM outputs a high level (e.g., one) control signal through the control terminal 34 to turn on the diode 30. When the diode 30 is turned on, a path between the diode 30 and the load 31 becomes short to make an impedance matching. Accordingly, the CDMA signal that has been received by the CDMA antenna 10 sequentially passes through the diode 30 and the transmission line 33, so as to be transmitted to the diplexer 14.

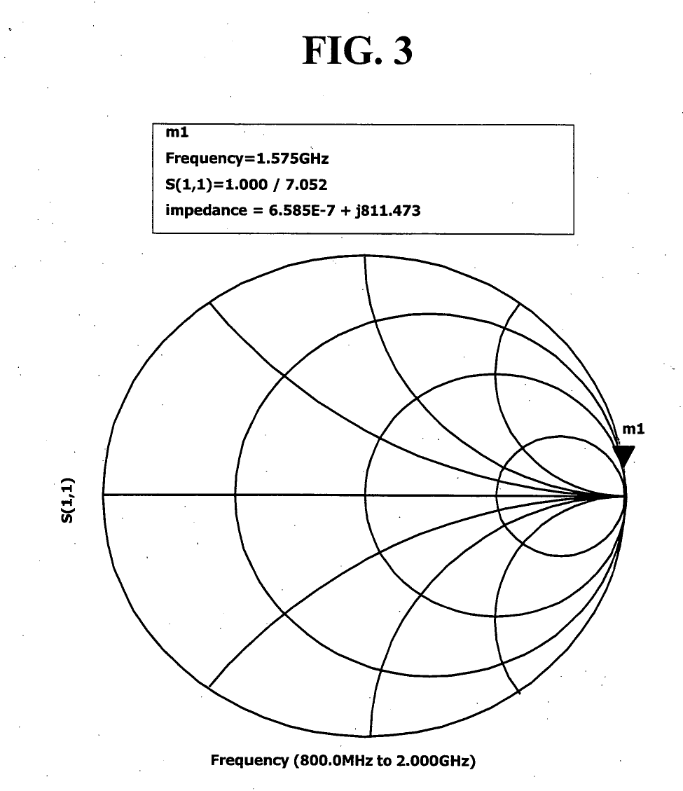

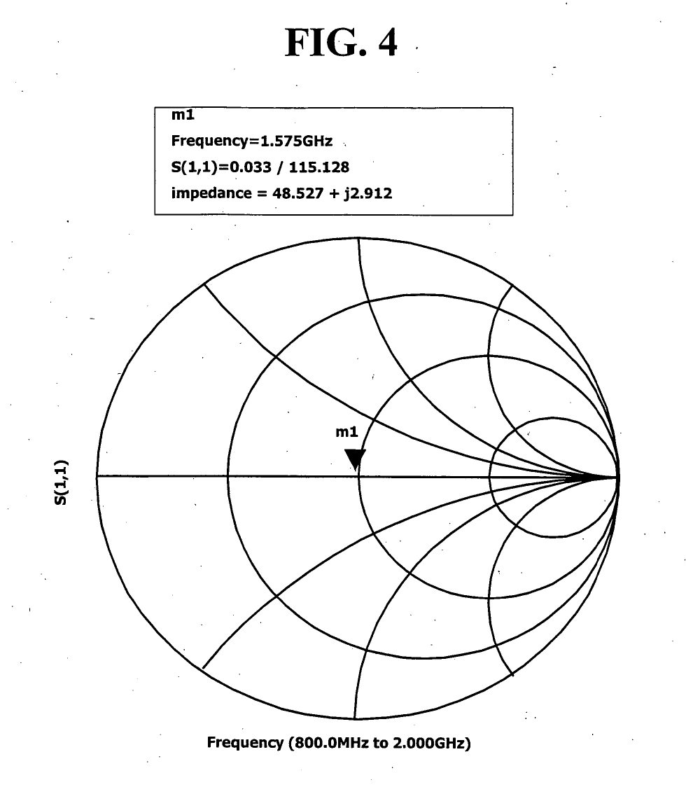

Referring to FIGS. 3 and 4, when the terminal operates in the GPS mode, the impedance of the CDMA antenna 10 becomes high (M1), so that the RF signal does not flow in the CDMA antenna 10. When the terminal operates in the CDMA mode, the impedance of the CDMA antenna 10 becomes low, so that the RF signal is transmitted as is to the diplexer 14.

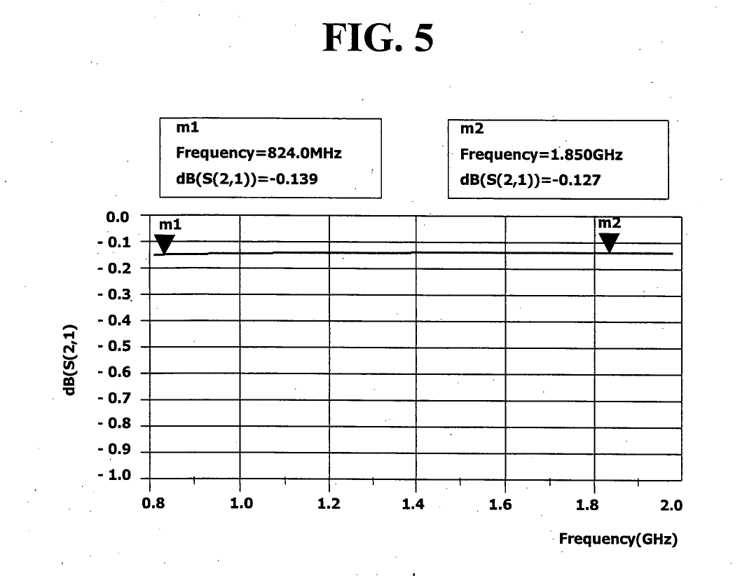

FIG. 5 is a table showing a signal loss of the switch circuit. As shown in FIG. 5, the switch circuit 12 shows a loss of cellular=0.139 dB, PCS=0.127 dB, in an exemplary embodiment, for the cellular (DCN) and the PCS signal of the CDMA (800 MHz, 1.9 GHz), which is too small to work as a loss.

In one embodiment of the present invention, the switch circuit 12 is connected to the CDMA antenna 10, to prevent GPS signal from flowing into the CDMA antenna. In another embodiment, the switch circuit 12 can be connected to the GPS antenna 20 to prevent the CDMA signal from flowing into the GPS antenna.

Diode 30 is used as a conducting means for controlling inflow of the RF signal according to an operation mode of the terminal. Diode 30 may comprise, for example, a MOS transistor, a simple switch, a pin diode or any other conductor that can meet the operational requirements of the invention.

Thus, by minimizing coupling between the GPS antenna and the CDMA antenna, using the simple switch circuit, when an antenna matching value is tuned to improve the radio sensitivity or the SAR of a received RF signal (GPS signal or the CDMA signal), the GPS antenna does not need to be tuned again as in the conventional art.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent function.

1. A signal coupling prevention system for a mobile communication terminal having a GPS function, comprising:
first and second antennas for receiving first and second RF signals of first and second frequencies, respectively;
a mobile switch for measuring performance characteristics of the second antenna; and
a switch circuit connected between the second antenna and the mobile switch for controlling flow of the first RF signal to the second antenna.

2. The apparatus of claim 1, wherein when the terminal is in a first mode, the switch circuit changes an input impedance of the second antenna to a first level to cut off flow of the first RF signal.

3. The apparatus of claim 1, wherein when the terminal is in a second mode, the switch circuit changes the input impedance of the second antenna to a second level to allow the second RF signal to flow to a diplexer.

4. The apparatus of claim 1, wherein the second signal comprises a DCN (Digital Cellular Network) signal and a PCS (Personal Communication Service) signal.

5. The apparatus of claim 1, wherein the switch circuit comprises:
a choke coil for transmitting a control signal to a diode;
a conducting means connected between the second antenna and a load for controlling flow of the second RF signal received by the second antenna according to the control signal; and
a transmission line for transmitting the second RF signal which has passed the conducting means, to the diplexer.

6. The apparatus of claim 5, wherein the conducting means comprises a pin diode.

7. The apparatus of claim 5, wherein the control signal is provided by a mobile station modem (MSM).

8. The apparatus of claim 5, wherein the control signal is provided at a first level in the GPS mode.

9. The apparatus of claim 5, wherein the control signal is provided at a second level in the CDMA mode.

10. The apparatus of claim 5, wherein the conducting means increases impedance of the second antenna to cut off inflow of the RF signal.

11. A signal coupling prevention system for a mobile communication terminal having separated GPS antenna and CDMA antenna for receiving respective GPS and CDMA signals, wherein a switch circuit for controlling an input impedance of the CDMA antenna is connected between the CDMA antenna and a mobile switch to cut off a first RF signal received by the CDMA antenna in a GPS operation mode and to allow passing of a second RF signal received by the CDMA antenna in a CDMA operation mode.

12. The apparatus of claim 11, wherein the first RF signal comprises a GPS signal and the second RF signal comprises a CDMA signal.

13. The apparatus of claim 11, wherein the switch circuit comprises:
a choke coil for transmitting a control signal for controlling input impedance of the CDMA antenna to a diode;
a conducting mechanism connected between the CDMA antenna and a load for cutting off or allowing the second RF signal to pass according to the control signal; and
a transmission line for connecting the conducting mechanism to a diplexer.

14. The apparatus of claim 13, wherein the conducting mechanism comprises a pin diode.

15. The apparatus of claim 13, wherein the conducting mechanism comprises a MOS transistor.

16. The apparatus of claim 13, wherein the control signal is provided from a mobile station modem (MSM) and has a low level in the GPS mode and a high level in the CDMA mode.

17. An antenna coupling preventing apparatus for a mobile communication terminal having a GPS antenna and a CDMA antenna to receive a GPS signal and a CDMA signal, wherein an input impedance of the CDMA antenna is maintained high in a GPS operation mode to cut off inflow of a GPS signal, and the input impedance of the CDMA antenna is maintained low in a CDMA operation mode to receive a CDMA signal.

18. An antenna coupling preventing apparatus comprising:
first and second antennas for receiving first and second RF signals respectively, having first and second frequencies; and
a switch circuit connected to the first antenna for cutting off inflow of the second RF signal, received by the second antenna, to the first antenna.

19. The apparatus of claim 18, wherein the first antenna receives a GPS (Global Positioning System) signal and the second antenna receives a CDMA (Code Division Multiple Access) signal.

20. The apparatus of claim 18, wherein the switch circuit is connected between the first antenna and a mobile switch measuring performance of wired characteristics of the first antenna.

21. The apparatus of claim 18, wherein the switch circuit maintains a first impedance in order to cut off inflow of the first signal to the second antenna.

22. The apparatus of claim 21, wherein the first impedance is a high impedance.

23. The apparatus of claim 18, wherein if the CDMA signal is received by the first antenna, the switch circuit maintains a second input impedance to prevent coupling with a GPS signal received by the second antenna.

24. The apparatus of claim 23, wherein the CDMA signal comprises at least of one of a PCS (Personal Communication Service) signal and a DCN (Digital Cellular Network) signal.

25. The apparatus of claim 18, wherein the switch circuit comprises:
a choke coil for transmitting a control signal controlling the input impedance of at least one of the first and second antennas;
a conducting mechanism connected to the first antenna and a load to control flow of the first RF signal received by the first antenna according to the control signal; and
a transmission line for transmitting the first RF signal to a diplexer.

26. The apparatus of claim 25, wherein the conducting mechanism comprises a pin diode.

27. The apparatus of claim 25, wherein the conducting mechanism comprises a MOS transistor.

28. The apparatus of claim 25, wherein the control signal is provided by a mobile station modem (MSM).

29. The apparatus of claim 25, wherein the control signal has a low level in the GPS mode.

30. The apparatus of claim 25, wherein the control signal has a high level in the CDMA mode.

31. A method for reducing coupling between a first antenna and a second antenna of a mobile terminal, wherein the first antenna is configured to receive a first signal and a second antenna is configured to receive a second signal, the method comprising:
setting a first impedance for the first antenna to prevent flow of the second signal in the first antenna; when the mobile terminal is in a second reception mode; and
setting a second impendence for the first antenna to allow flow of the first signal in the first antenna, when the mobile terminal is in a first reception mode.

32. The method of claim 31, wherein the first signal comprises a CDMA signal.

33. The method of claim 31, wherein the second signal comprises a GPS signal.

34. The method of claim 31, wherein the first reception mode is a CDMA reception mode.

35. The method of claim 31, wherein the second reception mode is a GPS reception mode.

36. The method of claim 31, wherein the first impedance is a high value.

37. The method of claim 31, wherein the second impedance is a low value.

38. The method of claim 31, wherein a control signal provided by a modem defines whether the mobile terminal is in at least one of the first and second reception modes.

39. The method of claim 37, wherein a switch mechanism controls the flow of the first and second signals in the first and second antennas based on the control signal's value.

40. The method of claim 31, wherein the first signal comprises a digital cellular network (DCN) signal.

41. The method of claim 31, wherein the first signal comprises a personal communication service (PCS) signal.
